(19) United States
(12) Patent Application Publication
(10) Pub. No.: US 2006/0243722 A1
(43) Pub. Date: Nov. 2, 2006

(54) Method for power regulation of a defroster heater and refrigeration device with integrated defroster heating

(75) Inventors: Ilias Manettas, Perama/Pireus (GR); Georg Strauss, Giengen (DE)

Correspondence Address: JOHN T. WINBURN, 100 BOSCH BOULEVARD, NEW BERN, NC, 28562, US

(73) Assignee: BSH Bosch und Siemens, Munich (DE)

(21) Appl. No.: 10/550,218

(22) PCT Filed: Apr. 5, 2004
(86) PCT No.: PCT/EP04/03608

§ 371 Date: Sep. 19, 2005

(30) Foreign Application Priority Data
Apr. 4, 2003 (DE) 103 15 522.8

(51) Int. Cl. H05B 1/02

(52) U.S. Cl. 219/497

(57) ABSTRACT

A refrigeration device including a method and apparatus for defroster heating. The defroster heating, such as supplied by an integrated defroster heater, includes a recording circuit for recording a voltage value of the supply voltage to the defroster heater. The recording circuit also generates a keyed control signal with a repetition rate dependent upon the recorded voltage value. The keyed control signal operates an interrupter for the supply power of the defroster heater. The repetition rate is set with relation to the recorded voltage value to limit power variations of the defroster heater caused by supply voltage variations.

The present invention relates to a method for power regulation of a defroster heating of a refrigeration device depending on a supply voltage of the defroster heating, and a refrigeration device with integrated defroster heating, in particular for carrying out said method.

The problem arises in refrigeration devices, such as for example refrigerators, where ice forms on the frigorific evaporator. This ice has an insulating effect, so that exchange of cold between the evaporator and the cooling chamber is made difficult. For this reason the ice must be thawed from time to time, for which purpose many refrigeration appliances, in particular so-called frost-free appliances, have defroster heating.

Such defroster heating can be controlled e.g. by means of ice sensors, in that the defrosting process is set in motion if the recorded quantity of ice exceeds a limit value, and discontinues when no more ice is detected. Such ice sensors are however expensive and are insufficiently reliable. Also, a large number of them is necessary to be able to reliably assess the total quantity of ice (the thickness whereof can vary from place to place).

A preferred solution therefore is, to periodically control defrosting procedures with a fixed preset duration with the assistance of a time switch element. Such control is easy, cost-effective and reliable. Its disadvantage, however, is that the time actually required for defrosting a given quantity of ice depends on the performance of the defroster heating and thus on the value of its supply voltage. The supply voltage provided by external supply mains is however not necessarily at that place of the mains identical to a specified nominal voltage, rather it can vary from place to place and time to time within a specified width of fluctuation by the nominal voltage.

If the supply voltage is too low it can eventuate that the preset defrosting period for complete defrosting is not sufficient, so that the quantity of ice becomes greater and greater over several defrosting cycles. This can impair the functioning of the refrigeration device.

If the defrosting time duration is preset such that even with the smallest value of the supply voltage in the permissible value range complete defrosting is guaranteed, then, when the supply voltage is higher more heat is released than is actually necessary for defrosting. This heat must then be discharged again through running the refrigerating machine more, thus impairing the efficiency of the refrigeration device.

The object of the invention therefore is to provide a novel method for power regulation of a defroster heating of a refrigeration device and a new refrigeration device, in particular for carrying out the inventive method, which the abovementioned disadvantages are eliminated.

This task is solved according to the present invention by a method for operating a defroster heating of a refrigeration device having the following procedural steps:
a) recording a voltage value of a supply current fed to the defroster heating,
b) generating a pulse-duty ratio of the supply current depending on the recorded voltage value,
c) supplying the defroster heating with the supply current keyed according to the generated pulse-duty ratio.

The above task is solved further by a refrigeration device with integrated defroster heating, in particular for carrying out the inventive method, with a recording circuit for recording a voltage value at a supply connector of the defroster heating and for generating a keyed control signal with a pulse-duty ratio depending on the recorded voltage value and a circuit breaker activated by the control signal for the supply current fed to the defroster heating.

With solutions known to date for defrosting evaporators in refrigeration devices the defroster heating is unkeyed independently of the mains voltage, that is, switched on with a pulse-duty ratio of 100%. As already mentioned this can result in there being either too much or too little heat supplied wherein there are fluctuations in voltage, since the heat output varies in proportion to the square of the supply voltage of the defroster heating. If there is too little heat, the defrosting procedure is often incomplete, and if there is too much heat this is associated with unnecessary energy consumption. By keying the defroster heating (including trickle heating, if required) depending on the supply voltage (in general mains voltage) these problems are avoided, in that the relative duty cycle of the defroster heating decreases with rising supply voltage.

On account of the simple realisation the dependency of the pulse-duty ratio on the supply voltage is preferably given by a step function with at least two, preferably three or four discrete values.

Within a permissible width of fluctuation of the supply voltage this step function can have at least two, preferably three or four discrete values.

The use of a step function corresponds to dividing the value range of the supply voltage into several intervals, whereby each interval is assigned one of the discrete values of the step function. To keep the width of fluctuation of the heat output in each interval approximately identical, the interval limits are preferably fixed such that upper and lower limit are in a ratio substantially the same for all intervals, preferably with a value between 1.1 and 1.2.

In a particularly preferred variant of the inventive method the keying is used when a previously defined undervoltage is exceeded. If this undervoltage is not reached, the heating is supplied continuously, that is, with a pulse-duty ratio of 1. This undervoltage should amount to at least ⅔ of the nominal voltage, at a nominal voltage of 230 volts indirect current (VAC) therefore ca. 150 VAC, preferably at least 70% of the nominal voltage (165 VAC). When the abovementioned undervoltage is exceeded the heating is operated keyed.

Further features and advantages of the invention will emerge from the following description of embodiments with respect to the attached figures, in which:

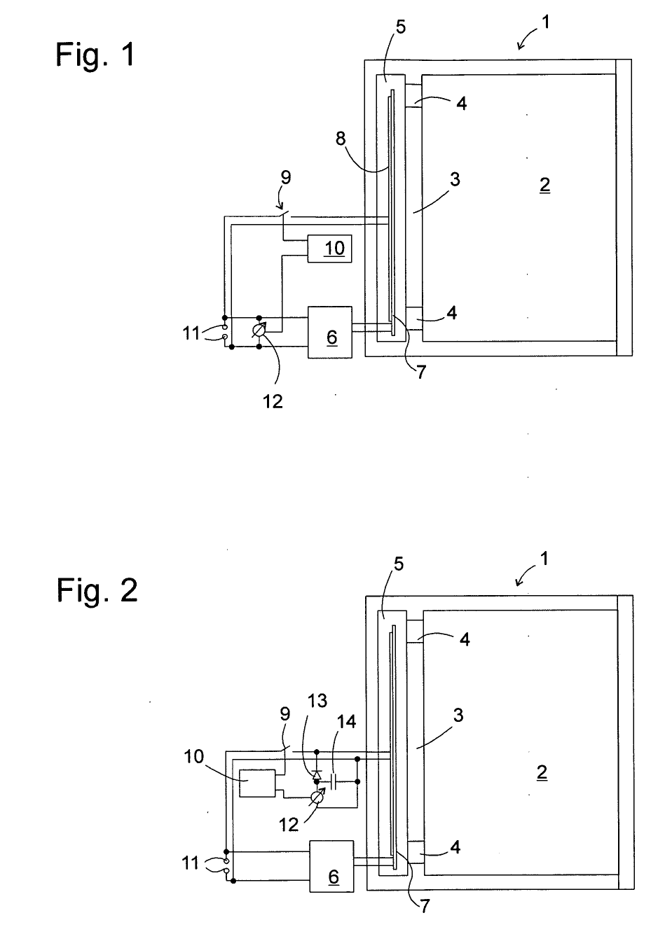

FIG. 1 is a first schematic illustration of a refrigeration device, from which the present invention is realised;

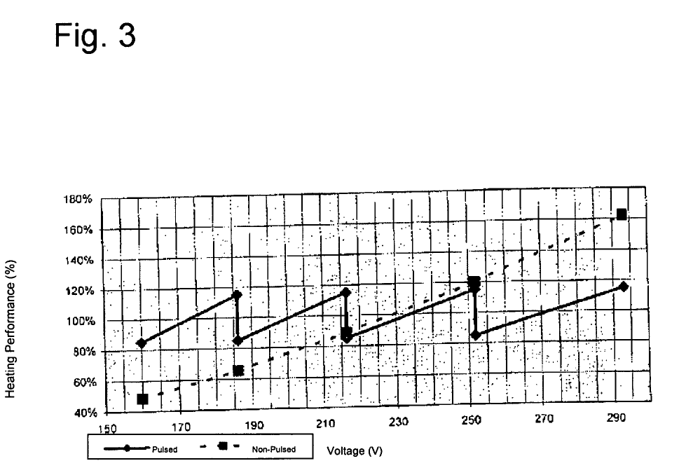

FIG. 2 is a second schematic illustration of an inventive refrigeration device; and

FIG. 3 shows a characteristic of the heat output as function of the supply voltage of a defroster heating according to the present invention.

FIG. 1 shows a clearly sketched no-frost refrigeration device, on which the present invention is realised. The refrigeration device in conventional terms comprises a heat-insulating housing 1, in the interior whereof a storage space 2 for cool goods and an evaporating chamber 5 separated from the storage space 2 by a partition 3 and communicating via openings 4 in the partition 3 are formed. Arranged in the evaporating chamber 5 is a plate-shaped evaporator 7 supplied with coolant by a refrigerating machine 6 and, in close contact with the latter, a defroster heating 8.

The defroster heating 8 can be supplied with a heating current via a circuit breaker 9 under the control of a control circuit 10. The defroster heating 8 is here connected to the lighting mains by way of clamps 11 parallel to the refrigerating machine 6, and its supply voltage is here a nominal 230 V indirect current (230 VAC). The circuit breaker 9 is preferably an output transistor or thyristor.

The control circuit 10 receives a voltage-measuring signal from a voltage meter circuit 12 connected parallel to the clamps 11. Depending on the received measured value the control circuit 10 rests on a pulse-duty ratio for controlling the circuit breaker 9 according to the following diagram:
160-186 VAC: 100% relative duty cycle
186-216 VAC: 74% relative duty cycle (on time: 22 s; off time: 8 s)
216-252 VAC: 55% relative duty cycle (on time: 16 s; off time: 14 s)
from 252 VAC: 40% relative duty cycle (on time: 12 s; off time: 18 s)

FIG. 2 is a schematic illustration of a second configuration of a no-frost refrigeration device according to the present invention. Components, corresponding to those already described with respect to FIG. 1, bear the same reference numerals and are not described again. The essential difference between the two arrangements is that in the configuration of FIG. 2 the voltage meter circuit 12 is arranged not between the clamps 11 and the circuit breaker 9, but is connected directly in behind the circuit breaker 9 parallel to the defroster heating 8 and can thus record its initial voltage free of parasitic inductions caused by pre-connected circuit components. So as to make the acquisition outcome of the measurement circuit 12 independent of the pulse-duty ratio of the circuit breakers 9, the measurement circuit 12 is connected to a diode 13 in series and to a condenser 14 in parallel, the result of which is that the peak value of one of the two half waves of the supply voltage rests constant on the voltage meter circuit 12.

FIG. 3 shows the results of the abovedescribed example compared to non-pulsed heating in diagram form.

In the case of non-pulsed heating the heat output rises proportionally with the square of the voltage, as illustrated by the dashed curve in FIG. 3. The heat output at nominal voltage of 230 VAC is here 100% the same. If the actual supply voltage of the refrigeration device is not 230 V, but for example 160 VAC, then heat output of only ca. 50% is achieved. If a fixed heating interval is preset for a defrosting process, which is such that with the nominal voltage an expected quantity of ice on the evaporator 7 defrosts completely, only half of this quantity defrosts at 160 VAC. If the actual supply voltage is above the nominal voltage, the defroster heating 8 gives off more heat during thawing than is necessary. For example at 290 VAC a heat output of ca. 160% is already achieved. This means that 60% of the heat energy is not required for defrosting and only loads the energy equilibrium of the refrigeration device.

According to the present invention the supply voltage range of 160 VAC to 290 VAC is divided into four intervals with the limits specified above in tabular form, whereby a fixed pulse-duty ratio is assigned to each interval. The upper and lower limits of the voltage intervals here are in a ratio of ca. 1.15, such that within an interval the output of the defroster heating is in a range of 100 15% by a nominal output.

These slight deviations in heat output by the nominal heat output enable uniform and better reproducible defrosting of the evaporator also with stronger fluctuations in voltage.

In general it can be said that with a growing number of voltage intervals deviation to the nominal defrosting output over a greater voltage range becomes less, and vice versa.

It is understood that the voltage intervals can also be selected differently.

If they are selected for example smaller still then their number increases, and deviation from the nominal defrosting output becomes less still. 10 VAC-voltage steps for example would be feasible. At the same time of course the relative duty cycles must match the voltage steps.

In the process however it should be noted that the strategy of defrosting periodically in each case during a fixed time interval is based on the supposition that the quantity of ice collecting between two defrosting procedures on the evaporator 7 remains constant. This requirement is naturally not exactly fulfilled, but the developing quantity of ice can vary, depending on the operating conditions (set cooling temperature, number of times the door is opened) or environmental conditions (temperature, humidity). It would technically not be a problem, to keep the quantity of heat given off during a defrosting process constant to a few percent or more precisely, however the associated expense has no advantages to it if the quantity of ice to be thawed fluctuates more strongly. A division of intervals of the interesting supply voltage range, such that in the individual intervals the heat output varies by not more than ca. 15%, therefore seems a favourable compromise between reproducibility of the heat energy and simplicity of realisation.

It is understood that the period of keying can be other than in the example specified hereinabove. In the example above the period is 30 s. The period can also be greater (e.g. 1 min.) or lesser (e.g. 15 s).

If, as in the current case, the supply current for the defroster heating 8 is an indirect current, it is important that the period for keying includes a large number of its periods, since a linear connection between pulse-duty ratio and heat output is guaranteed. At a usual frequency of the indirect current of 50 or 60 Hz this requisite is satisfied in any case if the test period is greater than 1 s.

1-11. (canceled)

12. A method for operating a defroster heating of a refrigeration device, comprising:
a) recording a voltage value of the supply voltage for the defroster heating;
b) generating a pulse-duty ratio for the supply current for said defroster heating depending on said recorded voltage value; and
c) supplying said defroster heating with said supply current keyed according to said generated pulse-duty ratio.

13. The method according to claim 12, including generating said pulse-duty ratio as a decreasing step function of said recorded voltage value.

14. The method according to claim 13, including forming at least two discrete values for said step function in a predetermined permissible range of fluctuation of said voltage value.

15. The method according to claim 13, including dividing the value range of said voltage value into a plurality of intervals, for each said interval assigning a fixed pulse-duty ratio and providing a ratio of upper to lower limit of each interval of between 1.1 and 1.2.

16. The method according to claim 13, including assigning voltage values below at least 150 VAC and a pulse-duty ratio of 1.

17. The method according to claim 16, including assigning voltage values below at least 165 VAC and a pulse-duty ratio of 1.

18. The method according to claim 12, including said supply current is an indirect alternating frequency current and keying said supply current with a keyed frequency, which is a fraction of said supply current alternating frequency.

19. A refrigeration device, comprising:
an integrated defroster heater;
a voltage supply coupled to said defroster heater;
a recording circuit coupled to said voltage supply for recording a voltage value supplied to said defroster heater;
said recording circuit generating a keyed control signal with a pulse-duty ratio dependent on the recorded voltage value; and
a circuit breaker activated by said control signal for the supply current fed to said defroster heater.

20. The refrigeration device according to claim 19, including said pulse-duty ratio is generated as a decreasing step function of said recorded voltage value.

21. The refrigeration device according to claim 20, including said step function has at least two discrete values.

22. The refrigeration device according to claim 21, including said step function has three or more discrete values.

23. The refrigeration device according to claim 20, including said value range of said voltage value is divided into a plurality of intervals, each said interval has a fixed pulse-duty ratio assigned, and the ratio from upper to lower limit of each said interval is between 1.1 and 1.2.

24. The refrigeration device according to claim 19, including said recording circuit assigns voltage values below 150 VAC and a pulse-duty ratio of 1.

25. The refrigeration device according to claim 24, including said recording circuit assigns voltage values below 165 VAC and a pulse-duty ratio of 1.

26. The refrigeration device according to claim 19, including said voltage supply provides an indirect alternating frequency current and said recording circuit keying said supply current with a keyed frequency, which is a fraction of said supply current alternating frequency.
